(19) United States
(12) Patent Application Publication
(10) Pub. No.: US 2003/0142598 A1
(43) Pub. Date: Jul. 31, 2003

(54) Optical pickup tilt control module and method for correcting and adjusting the tilt of an optical pickup

(76) Inventors: Wen-Te Chou, Chu Pei City (TW); Kun-Hung Hsieh, Hsin Chu City (TW); Chung-Hao Chen, Chung Li City (TW)

Correspondence Address: BIRCH STEWART KOLASCH & BIRCH, PO BOX 747, FALLS CHURCH, VA, 22040-0747, US

(21) Appl. No.: 10/345,327

(22) Filed: Jan. 16, 2003

(30) Foreign Application Priority Data
Jan. 28, 2002 (TW) 091101422

(51) Int. Cl. G11B 7/095

(52) U.S. Cl. 369/44.32; 369/53.19; 369/53.34

(57) ABSTRACT

An optical pickup tilt control module and a method for controlling a tilt value of an optical pickup to reduce the jitter value of a generated reproducing signal. The optical pickup tilt control module includes a reproducing signal generator, a jitter detector, a tilt controller and a tilt actuator. The reproducing signal generator receives a RF signal generated from the optical pickup and generates an EFM signal. The jitter detector receives the EFM signal and detects a jitter value of the EFM signal. The tilt controller generates optimum tilt control values during a correction stage and outputs a tilt control value according to a track position of reproduction data during an adjusting stage. The tilt actuator controls the tilt of the optical pickup according to the tilt control value.

### BACKGROUND OF THE INVENTION

1. Field of the Invention

The invention relates generally to an optical disk access apparatus, and more particularly to an optical pickup tilt control module and a method for adjusting a tilt of an optical pickup for reducing the jitter of the EFM (Eight to Fourteen Modulation) signals.

2. Description of the Related Art

An optical pickup in an optical recording and reading device usually needs an actuator to adjust the position and angle of an object lens so as to make the reading/recording information (e.g., EFM signals) from/to the optical apparatus more robust. The actuator can precisely move the optical pickup to the desired position and angle. However, when the to-be-read or to-be-recorded optical disk is curved or the tilt of the optical pickup is incorrect, the read or recorded information may be deteriorated. In order to compensate for the information deterioration, it is necessary to measure the relative tilt between the optical pickup and the optical disk and properly adjust the tilt of the optical pickup.

FIG. 1 shows a conventional architecture of a tilt adjusting apparatus. Referring to FIG. 1, the apparatus includes an optical pickup 10, a tilt detector (12, 14a, 14b) and an object lens 16. The optical pickup 10 is rotatably mounted on the rotating shaft 18 and is rotated under the control of an actuator (not shown). The tilt detector includes a light emitter 12 for emitting light rays, and light receivers 14a and 14b for receiving reflected light rays and thus detecting the tilt value, which is utilized to control the actuator. In this method, however, the relative tilt between the optical pickup and the optical disk is directly utilized to adjust the tilt of the optical pickup without considering the actual signal jitter.

FIG. 2 is a block diagram showing an optical apparatus, which is capable of adjusting the tilt of the optical pickup and is disclosed in U.S. Pat. No. 6,282,161 B1. Referring to FIG. 2, the optical apparatus includes an optical pickup 20, an optical pickup support unit 24, a displacement sensor 26, a reproducing signal generator 32, a jitter detector 34, a tilt controlling unit 36, a memory 38 and a tilt driving circuit unit 40. The optical pickup support unit 24 is axially supported by a rotating shaft 22. A tilt driving motor 30 and a tilt driving unit 28 are used to adjust the tilt of the optical pickup support unit 24. The displacement sensor 26 is mounted on a bottom surface of the optical pickup support unit 24 to detect the relative tilt between the optical pickup and the optical disk. The reproducing signal generator 32 generates a reproducing signal from the output signal of the optical pickup. The jitter detector 34 detects the jitter value of the reproducing signal. The tilt controlling unit 36 receives a displacement signal output from the displacement sensor 26 and outputs a tilt signal. The tilt driving circuit unit 40 receives the tilt signal and generates a control signal to control the tilt driving motor 30.

FIG. 3 is a flow chart showing the method for controlling the optical apparatus. Referring to FIG. 3, the control method includes the steps of: calculating a mean displacement value S0 (S300); setting the tilt driving unit by the displacement value S0 (S302); moving the optical pickup to the disk's inner circumference to optimize the focus and tracking (S304); detecting the optimum tilt value and displacement value, S-inner, in the inner circumference (S306); moving the optical pickup to the disk's outer circumference to optimize the focus and tracking (S308); detecting the optimum tilt value and displacement value, S-outer, in the outer circumference (S310); storing optimum displacement values, S-inner and S-outer, (S312); calculating the tilt control value during reproducing of disk (S314); and adjusting the tilt value of the optical pickup by the tilt control value.

Although the above-mentioned system and method can detect the tilt value of the optical pickup under the optimum focus and tracking, the system still has to detect the displacement value by the displacement sensor.

### SUMMARY OF THE INVENTION

In view of the above-mentioned problem, it is therefore an object of the invention to provide an optical disk access apparatus capable of correctly controlling the tilt value of an optical pickup without using a displacement sensor, and a method for adjusting the tilt of the optical pickup.

To achieve the above-mentioned object, the apparatus for accessing optical disk data of the present invention includes an optical pickup tilt control module for controlling a tilt value of an optical pickup and decreasing a jitter value of a generated reproducing signal. The optical pickup tilt control module includes a reproducing signal generator, a jitter detector, a tilt controller and a tilt actuator. The reproducing signal generator receives a RF signal generated from the optical pickup and generates an EFM signal. The jitter detector receives the EFM signal and detects the jitter value of the EFM signal. The tilt controller outputs different tilt control values during a correction stage, selects a preferred tilt control value, and generates a tilt control value according to a track position of reproducing signal during an adjusting stage. The tilt actuator receives the tilt control value and generates a tilt control signal to drive the optical pickup to a specified angle.

The invention also provides a method for correcting a tilt of an optical pickup, comprising the steps of:

(a) moving the optical pickup to an inner circumference of an optical disk;

(b) outputting a set of tilt control values to control the tilt of the optical pickup;

(c) detecting jitter values under each tilt control value;

(d) selecting a first tilt control value corresponding to a jitter value smaller than a jitter threshold as an inner tilt control value;

(e) moving the optical pickup to an outer circumference of the optical disk;

(f) outputting a set of tilt control values to control the tilt of the optical pickup;

(g) detecting jitter values for each tilt control value;

(h) selecting a second tilt control value corresponding to a jitter value smaller than the jitter threshold as an outer tilt control value;

(i) calculating track zone tilt control values according to the inner tilt control value and the outer tilt control value; and

(j) storing the inner tilt control value, track zone tilt control values and the outer tilt control value.

The method for correcting a tilt of an optical pickup is executed when the optical disk is inserted into an apparatus for accessing optical disk data.

The invention also provides a method for adjusting a tilt of an optical pickup, comprising the steps of:

(a) obtaining a track position of an optical pickup;

(b) reading a tilt control value from a memory according to the track position; and

(c) outputting the tilt control value to control the tilt of the optical pickup.

The method for adjusting a tilt of an optical pickup is executed when the apparatus is accessing optical disk data.

### BRIEF DESCRIPTION OF THE DRAWINGS

FIG. 1 shows a conventional architecture of a tilt adjusting apparatus.

FIG. 2 is a block diagram showing a conventional optical apparatus capable of adjusting the tilt of the optical pickup.

FIG. 3 is a flow chart of a method for controlling the optical apparatus of FIG. 2.

FIG. 4 is a block diagram showing an apparatus for accessing optical disk data according to the invention.

FIG. 5 is a simulation graph showing the relation between the tilt control signal value of the tilt controller and the jitter value during the correcting stage.

FIG. 6 is a flow chart of the steps of the correction stage of the present invention.

FIG. 7 is a flow chart of the steps of the reproducing stage of the present invention.

FIG. 8 is a flow chart of another embodiment of the correction stage the present invention.

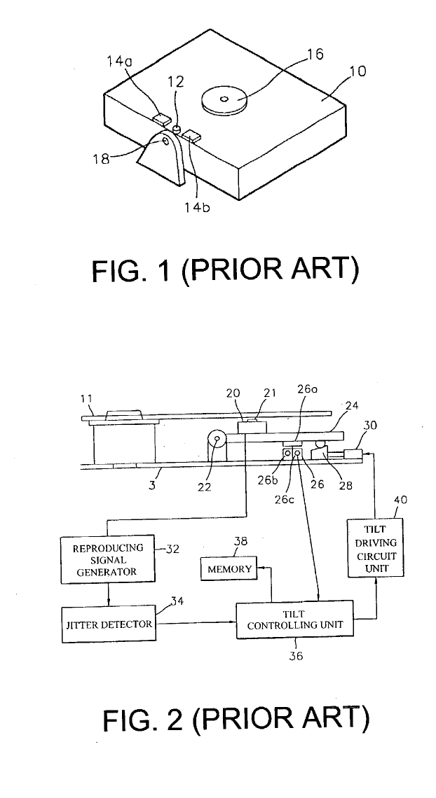

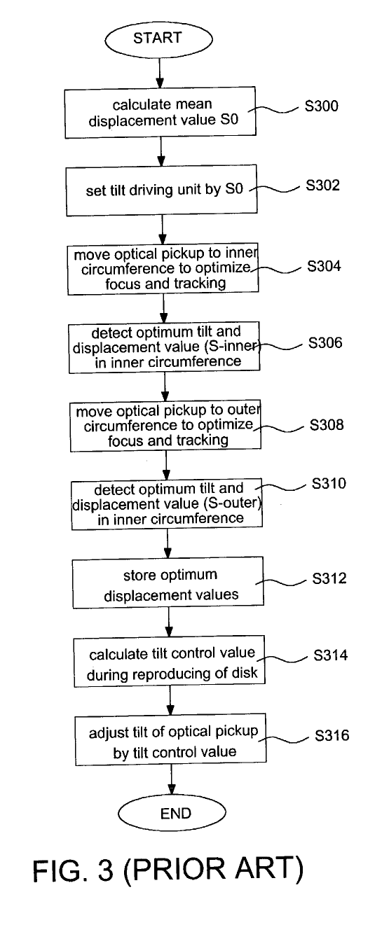

### DETAILED DESCRIPTION OF THE INVENTION

The apparatus for accessing optical disk data and method for correcting and adjusting the tilt of the optical pickup of the invention will be described with reference to the accompanying drawings.

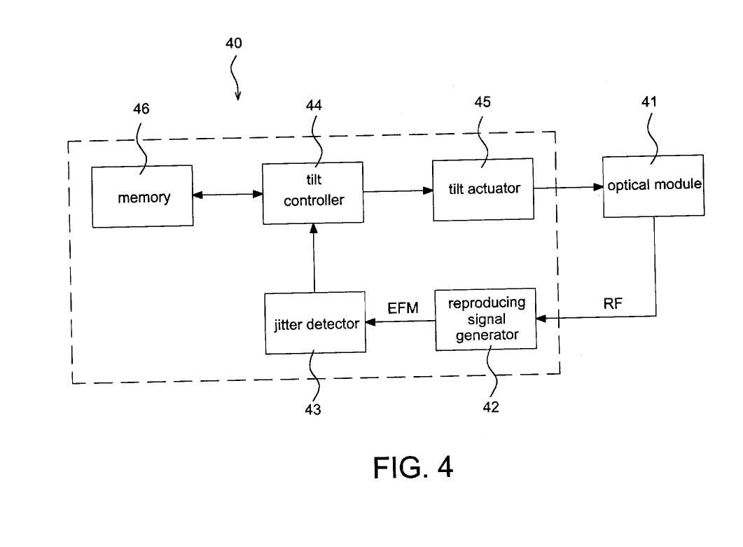

FIG. 4 is a block diagram showing an apparatus for accessing optical disk data of the present invention. Referring to FIG. 4, the apparatus for accessing optical disk data of the invention includes a tilt control module 40 for controlling the tilt value of the optical pickup of the optical module 41 so as to effectively decrease the jitter value of the reproducing signal. The tilt control module 40 includes a reproducing signal generator 42, a jitter detector 43, a tilt controller 44, a tilt actuator 45 and a memory 46.

The reproducing signal generator 42 converts the RF (radio frequency) signal generated from the optical pickup into an EFM (Eight to Fourteen Modulation) signal. For example, a slicer is used to slice the RF signal into EFM signal with data 0 and data 1. The jitter detector 43 receives the EFM signal and detects the jitter value of the EFM signal. In general, the jitter value is the phase wandering degree in the leading or trailing edges of the EFM signal.

The tilt controller 44 has two stages, including a correction stage and a reproducing stage. During the correction stage, the tilt controller 44 generates an optimum tilt control value for each track zone or generates an optimum tilt control value for all tracks. The tilt controller 44 outputs a set of tilt control values to control the tilt of the optical pickup, receives the corresponding jitter value for each control value and selects a tilt control value with a minimum jitter value as the optimum tilt control value. The tilt controller 44 also can select a tilt control value with a jitter value smaller than a jitter threshold value as the optimum tilt control value. During the reproducing stage of disk data reproducing, the tilt controller 44 reads a corresponding tilt control value to control the tilt value of the optical pickup according to the track position of the optical pickup.

The tilt actuator 45 outputs a driving signal to the optical module 41 to control the tilt of the optical pickup according to the tilt control value output from the tilt controller 44. The tilt control value is a digital signal stored in the memory 46. A DAC (Digital/Analog Converter) (not shown) converts the tilt control value and outputs an analog tilt control signal to the tilt actuator 45. The tilt actuator 45 converts the analog tilt control signal, such as a voltage signal ranging from 0 to 4V, into a driving signal for driving the optical pickup to rotate.

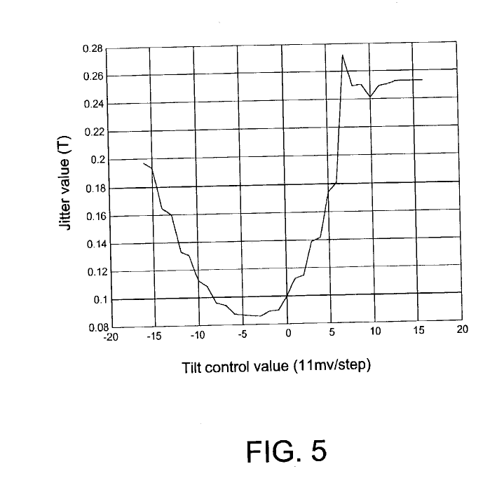

FIG. 5 is a simulation graph showing the relation between the tilt control value and the jitter value during the correcting stage, where the X-axis represents the tilt control value, the Y-axis represents the jitter value, and the unit of the Y-axis is the unit T of the EFM signal. As shown in FIG. 5, when the tilt controller 44 outputs a set of tilt control values, the jitter value detected by the jitter detector 43 changes accordingly, and the relation between the tilt control value and the jitter value can be represented as a V-shaped curve. Consequently, the tilt controller 44 can calculate a preferred tilt control value according to the V-shaped curve so as to decrease the jitter value of the EFM signal during reproducing. Taking the curve of FIG. 5 as an example, if the jitter threshold value is (0.1T), the preferred tilt control value ranges from (−8) to (0) and the optimum tilt control value equals (−4). Of course, an approaching method may also be used to find the optimum tilt control value or the preferred tilt control value.

If the disk is flat, the same optimum tilt control value can be used at each track zone. However, the disk may sometimes be curved, and the tilt of the optical pickup relative to the disk's inner circumference and outer circumference are different. Thus, the reading and recording operations of the overall optical disk cannot be controlled using the same tilt control value. The present invention solves this problem by calculating the inner optimum tilt control value, DAC-inner, for the disk's inner circumference and the outer optimum tilt control value, DAC-outer, for the disk's outer circumference. Then, the optimum tilt control values for other tracks are calculated using the interpolation method according to the inner optimum tilt control value, DAC-inner, and outer optimum tilt control value, DAC-outer, and recorded in the memory 46. Of course, it is also possible to divide the tracks of the disk into a plurality of track zones, and then to calculate the optimum tilt control values for each track zone and record the optimum tilt control values in the memory 46. Since the optimum tilt control value for each track zone is calculated and stored in the memory, the apparatus does not need to measure the actual tilt value by a displacement sensor so as to lower the cost. In addition, even though the actual tilt value of the optical pickup slightly deviates from a standard value, the correctness of the optical disk access apparatus will not be influenced because a jitter value smaller than the jitter threshold value is acceptable.

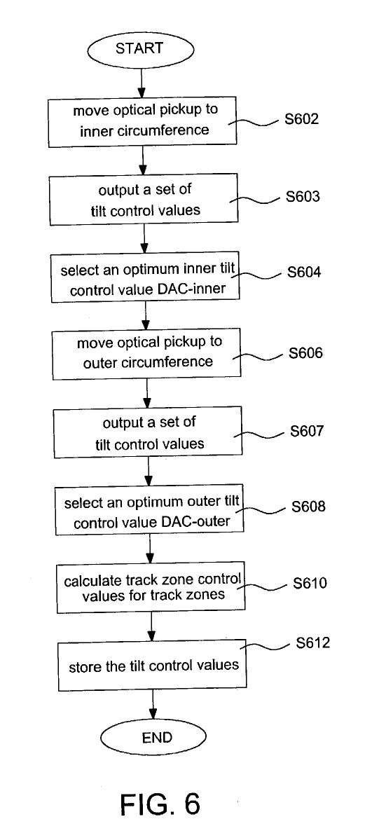

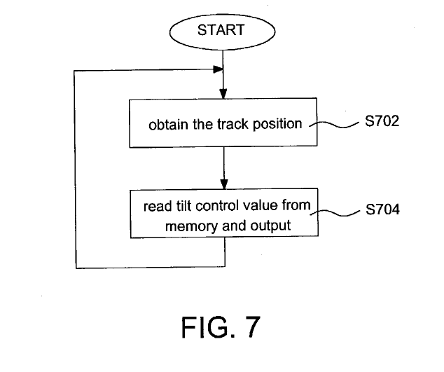

The method for adjusting the tilt of the optical pickup of the invention will be described hereinbelow. The method of the invention includes a correction stage and a reproducing stage. When the optical disk is inserted into the apparatus, the correction stage is started to generate the optimum (or preferred) tilt control values for track zones and stores the optimum (or preferred) tilt control values into the memory 46. FIG. 6 shows a flow chart of the correction stage. On the other hand, when the apparatus is accessing data in the optical disk, the reproducing stage is started to read the optimum tilt control values from the memory 46 and outputs the values to the tilt actuator 45 according to the track position of the optical pickup. FIG. 7 shows a flow chart of the reproducing stage. As shown in FIG. 6, the correction stage includes the following steps:

Step S602: The optical pickup is moved to the innermost circumference (e.g., the lead-in area, which is about 23 mm distant from the center) of the optical disk.

Step S603: The tilt controller 44 outputs a set of tilt control values and receives the jitter values corresponding to each tilt control value. That is, a jitter curve like FIG. 5 is generated.

Step S604: A tilt control value corresponding to the minimum jitter value is selected as an optimum inner tilt control value, DAC-inner, of the inner circumference according to the jitter curve generated in step S603.

Step S606: The optical pickup is moved to the outermost circumference (e.g., the lead-out area, which is about 58 mm distant from the center) of the optical disk.

Step S607: The tilt controller 44 outputs a set of tilt control values and receives the jitter value for each tilt control value. That is, a jitter curve like FIG. 5 is generated.

Step S608: A tilt control value corresponding to the minimum jitter value is selected as an optimum outer tilt control value, DAC-outer, according to the jitter curve generated in step S607.

Step S610: Calculate the optimum track zone tilt control values in different track zones between the innermost and outermost circumferences. That is, the optimum tilt control values corresponding to the track zones are calculated using the interpolation method or other similar methods based on the optimum inner tilt control value, DAC-inner, and optimum outer tilt control value, DAC-outer.

Step S612: Store the optimum inner tilt control value, DAC-inner, and optimum outer tilt control value, DAC-outer, in the memory 46.

Consequently, after the optical disk is inserted into the optical disk access apparatus and the correction operation is finished, the memory 46 stores the. optimum tilt control values corresponding to each track zones. Accordingly, when the optical disk access apparatus reads data on the optical disk, the optimum tilt value of the optical pickup can be controlled according to the optimum tilt control values stored in the memory 46 so that the jitter value can be decreased to a value smaller than the threshold value. The method for adjusting the tilt of the optical pickup of the invention will be described with reference to FIG. 7.

Step S702: The tilt controller 44 obtains the track position of the optical pickup from the control system (not shown) of the optical disk access apparatus.

Step S704: The tilt controller 44 reads the optimum tilt control value from the memory 46 according to the track position and outputs the tilt control value.

Consequently, the apparatus for accessing optical disk data and method for correcting and adjusting the tilt of the optical pickup of the invention can correctly control the tilt value of the optical pickup without a displacement sensor, thereby reducing the jitter value of the reproducing signal.

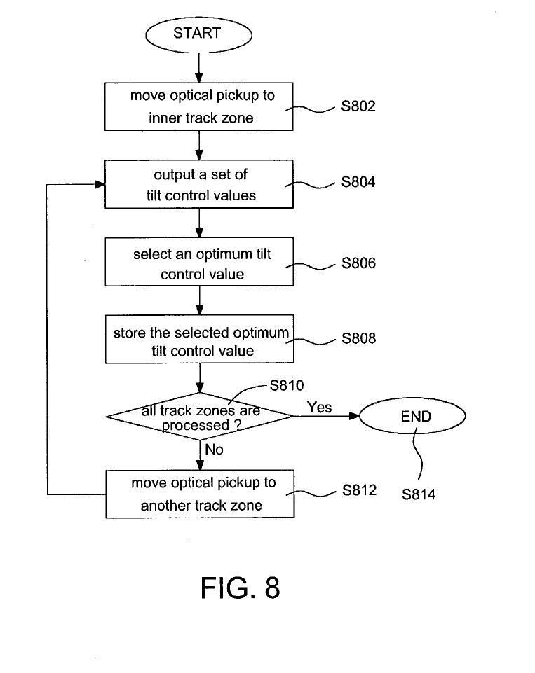

FIG. 8 shows a flow chart of another embodiment of the correction stage. As shown in FIG. 8, the correction stage includes the following steps:

Step S802: Move the optical pickup to a track zone of the optical disk.

Step S804: Output a set of tilt control values to control the optical pickup in different tilts and receive the jitter values corresponding to each tilt control value. That is, a jitter curve like FIG. 5 is generated.

Step S806: A tilt control value corresponding to the minimum jitter value is selected as an optimum tilt control value of the track zone according to the jitter curve generated in step S804.

Step S808: Store the selected optimum tilt control value into a memory.

Step S810: Determine whether all the track zones are processed. If all the track zones are processed, jump to step S814, otherwise jump to step S812.

Step S812: Move the optical pickup to another track zone of the optical disk and jump back to step S804.

Step S814: End.

The flowchart in FIG. 8 is to select the optimum track zone tilt control value for each track zone, but the flowchart in the FIG. 6 is to select the inner and outer optimum tilt control values and then calculate the optimum track zone tilt control values for other track zones by interpolation or other method based on the inner and outer optimum tilt control values.

While certain exemplary embodiments have been described and shown in the accompanying drawings, it is to be understood that such embodiments are merely illustrative of and not restrictive to the broad invention, and that this invention is not limited to the specific construction and arrangement shown and described, since various other modifications may occur to those ordinarily skilled in the art.

What is claimed is:

1. An optical pickup tilt control module for controlling a tilt value of an optical pickup, comprising:
a reproducing signal generator for receiving a radio frequency signal generated from an optical pickup and generating an EFM signal;
a jitter detector for receiving the EFM signal and detecting a jitter value of the EFM signal;
a tilt controller for generating a plurality of optimum tilt control values for track zones during a correction stage and outputting an optimum tilt control value according to the track position of the optical pickup during a reproducing stage; and
a tilt actuator for receiving the tilt control value output from the tilt controller and generating a tilt control signal to drive the optical pickup to tilt.

2. The apparatus according to claim 1, further comprising a memory for storing the optimum tilt control value output from the tilt controller.

3. A method for correcting a tilt of an optical pickup, comprising the steps of:
moving an optical pickup to an inner circumference of an optical disk;
outputting a set of tilt control values to control the tilt of the optical pickup;
detecting jitter values for each tilt control value;
selecting a first tilt control value corresponding to a jitter value smaller than a jitter threshold as an inner tilt control value;
moving the optical pickup to an outer circumference of the optical disk;
outputting a set of tilt control values to control the tilt of the optical pickup;
detecting jitter values for each tilt control value;
selecting a second tilt control value corresponding to a jitter value smaller than the jitter threshold as an outer tilt control value;
calculating track zone tilt control values according to the inner tilt control value and the outer tilt control value; and
storing the inner tilt control value, track zone tilt control values and the outer tilt control value.

4. The method according to claim 3, wherein the method is applied to an apparatus for accessing optical disk data.

5. The method according to claim 4, wherein the method is executed when the optical disk is inserted into the apparatus for accessing optical disk data.

6. The method according to claim 3, wherein the step of selecting a first tilt control value is to select a control value corresponding to a minimum jitter value as the inner tilt control value.

7. The method according to claim 3, wherein the step of selecting a second tilt control value is to select a control value corresponding to a minimum jitter value as the outer tilt control value.

8. The method according to claim 3, wherein the step of calculating track zone tilt control values uses an interpolation method to calculate the track zone tilt control values based on the positions of track zones between the inner circumference and the outer circumference.

9. A method for correcting and adjusting a tilt of an optical pickup, comprising the steps of:
a) moving an optical pickup to a track zone of an optical disk;
b) outputting a set of tilt control values to control the tilt of the optical pickup;
c) detecting jitter values for each tilt control value;
d) selecting a track zone tilt control value corresponding to a jitter value smaller than a jitter threshold as an inner tilt control value;
e) repeating the steps a) to d) to generate track zone tilt control values for all track zones; and
f) storing the track zone tilt control values.

10. The method according to claim 9, wherein the step of selecting a track zone tilt control includes selecting a control value corresponding to a minimum jitter value as the track zone tilt control value.

11. A method for correcting a tilt of an optical pickup, comprising the steps of:
moving an optical pickup to a track with recorded data of an optical disk;
outputting a set of tilt control values to control the tilt of the optical pickup;
detecting jitter values for each tilt control value;
selecting a tilt control value corresponding to a jitter value smaller than a jitter threshold as an optimum tilt control value; and
storing the optimum tilt control value.

12. The method according to claim 1 1, wherein the step of selecting a tilt control value includes selecting a control value corresponding to a minimum jitter value as the optimum tilt control value.

13. A method for adjusting a tilt of an optical pickup, comprising the steps of:
obtaining a track position of an optical pickup;
reading a tilt control value from a memory according to the track position; and
outputting the tilt control value to control the tilt of the optical pickup.

14. The method according to claim 13, wherein the method is applied to an apparatus for accessing optical disk data.

15. The method according to claim 14, wherein the method is executed when the apparatus reproduces or records optical disk data.
